(19) United States
(12) Patent Application Publication
(10) Pub. No.: US 2013/0326151 A1
(43) Pub. Date: Dec. 5, 2013

(54) MEMORY MANAGEMENT SYSTEM AND PROGRAM

(71) Applicant: Semiconductor Energy Laboratory Co., Ltd., Atsugi-shi (JP)

(72) Inventors: Yuji Iwaki, Isehara (JP); Toshikazu Kondo, Atsugi (JP)

(73) Assignee: Semiconductor Energy Laboratory Co., Ltd., Atsugi-shi (JP)

(21) Appl. No.: 13/903,210

(22) Filed: May 28, 2013

(30) Foreign Application Priority Data
May 31, 2012 (JP) 2012-124036

(51) Int. Cl. G06F 12/10; G06F 12/08

(52) U.S. Cl. CPC G06F 12/1063; G06F 12/0862
USPC 711/137; 711/208

(57) ABSTRACT

To reduce power consumption of a computer or the like, a nonvolatile memory divided into a plurality of segments is applied to main memory used for virtual storage management. Thus, power supply even to a segment having a physical address that is being used can be stopped. As a result, power consumption of the computer or the like performing virtual storage management can be reduced.

### BACKGROUND OF THE INVENTION

1. Field of the Invention

The present invention relates to memory management systems and particularly to a memory management system performing virtual storage management. The present invention also relates to a program for causing a computer or the like to perform virtual storage management.

2. Description of the Related Art

In a computer, a plurality of programs are often performed pseudo-concurrently (which can be referred to as multitasking or multiprogramming). Specifically, in the computer, processes, which are units for executing each program, are often switched as appropriate to run the processes successively. In this case, in performing each process, at least the process that is actually being executed needs to be stored in main memory of the computer. In view of this, virtual storage management (also referred to as virtual address space management) is a technique for virtually providing storage capacity larger than the storage capacity of the main memory in the computer.

Specifically, contiguous virtual addresses per process are allocated in a virtual address space, and various kinds of code or data are placed at each of the virtual addresses. On the other hand, some of the various kinds of code or data located in the virtual address space are placed at a plurality of physical addresses included in a physical address space in the main memory. A table (also referred to as a page table) for mapping the virtual and physical addresses is managed by an operating system (OS).

The computer includes a memory management unit (MMU) that adds and deletes various kinds of code or data placed in a physical address space (allocates and deallocates physical addresses). A cache for a specific page table (a translation lookaside buffer (TLB)) is provided in the memory management unit (MMU) in some cases. The operating system (OS) determines whether to add various kinds of code or data in the virtual address space by the memory management unit (MMU) and whether to delete them by the memory management unit (MMU).

There has been developed a technique for reducing power consumption by selective power supply to a physical memory space in a computer in which the virtual storage management is performed. Specifically, there has been developed a technique for reducing power consumption in such a manner that a physical memory space is divided into a plurality of regions (also referred to as segments) and power supply to at least one of the divided regions is stopped. For example, Patent Document 1 discloses a technique in which power supply to a specific region (a memory bank) where no physical addresses are being used is stopped.

Note that stop of power supply in this specification means that power supply voltage (a high power supply potential and a low power supply potential) is not supplied or that power supply voltage (a difference between a high power supply potential and a low power supply potential) is made zero or substantially zero.

### REFERENCE

Patent Document 1: Japanese Published Patent Application No. H9-212416

### SUMMARY OF THE INVENTION

An object of one embodiment of the present invention is to reduce power consumption of a computer or the like.

A feature of one embodiment of the present invention lies in that a nonvolatile memory divided into a plurality of segments is applied to main memory used for virtual storage management.

For example, one embodiment of the present invention is a memory management system including a nonvolatile memory divided into a plurality of segments; and a memory power supply control unit configured to control power supply to the nonvolatile memory in the plurality of segments independently. The memory power supply control unit controls power supply to the plurality of segments depending on utilization situation of the plurality of physical addresses (e.g. utilization rate of the plurality of physical addresses) included in each of the plurality of segments in the virtual storage management.

One embodiment of the present invention is a program for making a memory management system configured to perform virtual storage management using a nonvolatile memory divided into a plurality of segments, control power supply to the plurality of segments depending on utilization situation of a plurality of physical addresses included in each of the plurality of segments in the virtual storage management.

Note that a nonvolatile memory in this specification is a memory that can retain information even when the power supply voltage is not supplied to the memory or when the power supply voltage supplied to the memory is made zero or substantially zero.

A memory management system in one embodiment of the present invention includes a nonvolatile memory divided into a plurality of segments, whereby power supply even to a segment having a physical address that is being used can be stopped. As a result, power consumption of the memory management system can be reduced.

A program in one embodiment of the present invention controls power supply to a nonvolatile memory divided into a plurality of segments. Thus, power supply even to a segment having a physical address that is being used can be stopped. Consequently, power consumption of the memory can be reduced.

### BRIEF DESCRIPTION OF THE DRAWINGS

In the accompanying drawings:

FIG. 1 illustrates an example of the structure of a memory management system;

FIG. 2 is a schematic diagram showing a concept of virtual storage management;

FIG. 3 is a flowchart illustrating an example of the flow of virtual storage management;

FIG. 4 is a flowchart illustrating an example of the flow of virtual storage management;

FIG. 5 is a flowchart illustrating an example of the flow of virtual storage management;

FIG. 6A is a circuit diagram illustrating an example of the structure of a segment, and

FIGS. 6B to 6E are circuit diagrams each illustrating an example of the structure of a memory cell;

FIG. 7 is a cross-sectional view illustrating an example of the structure of a memory cell; and

FIGS. 8A to 8F illustrate specific examples of electronic devices.

### DETAILED DESCRIPTION OF THE INVENTION

Embodiments of the present invention will be described below in detail. Note that the present invention is not limited to the description below, and a variety of changes can be made without departing from the spirit and scope of the present invention. Therefore, the present invention should not be construed as being limited to the description below.

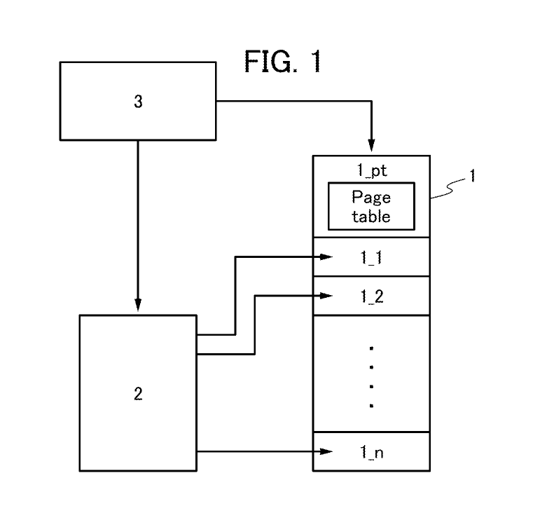

### <1. Structure Example of Memory Management System: FIG. 1>

FIG. 1 illustrates an example of the structure of a memory management system in one embodiment of the present invention. The memory management system illustrated in FIG. 1 includes a nonvolatile memory 1 divided into a plurality of segments 1_pt and 1_1 to 1_{—}n, a memory power supply control unit 2 that controls power supply to the plurality of segments 1_1 to 1_{—}n independently, and a memory management unit 3 that performs virtual storage management by looking up a table (a page table) for mapping a plurality of virtual addresses in a virtual address space and a plurality of physical addresses in each of the plurality of segments 1_1 to 1_{—}n. Note that the segment 1_pt in which the page table is located may be volatile instead of nonvolatile. A cache for the page table (a translation lookaside buffer (TLB)) may be provided in the memory management unit 3.

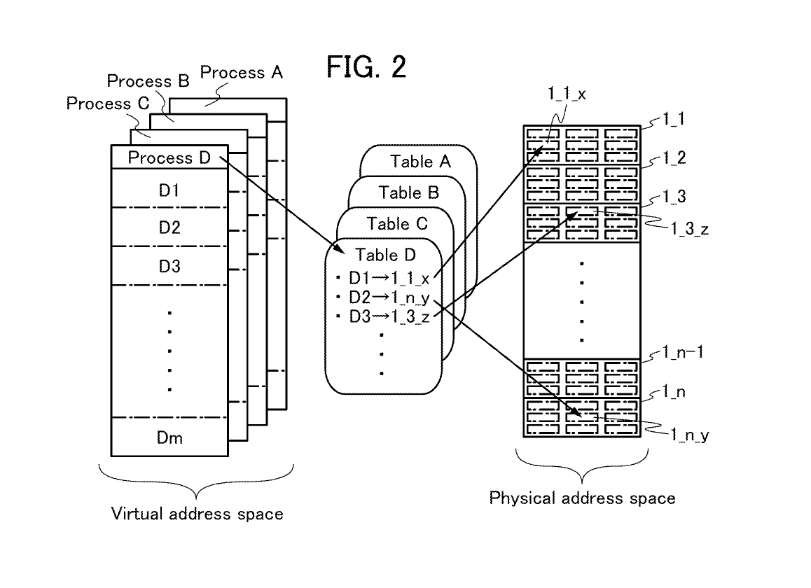

### <1-1. Overview of Virtual Storage Management: FIG. 2>

FIG. 2 is a schematic diagram for explaining the outline of virtual storage management performed in the memory management system illustrated in FIG. 1. FIG. 2 illustrates processes A to D in a virtual address space, the plurality of segments 1_1 to 1_{—}n in a physical address space, and tables (page tables) that show mapping between a plurality of virtual addresses (e.g., virtual addresses D1, D2, D3, and Dm) allocated to each of the processes A to D and a plurality of physical addresses (e.g., physical addresses 1_1_{—}x, 1_3_{—}z, and 1_{—}n_{—}y). Note that various kinds of code or data can be placed at each of the plurality of physical addresses. A flag to indicate whether power is supplied to a segment including a physical address mapped to a virtual address may be set in the page table. In this case, the power supply state of the segment can be judged when an operating system (OS) looks up the page table. That is, the processing speed of the virtual storage management can be increased.

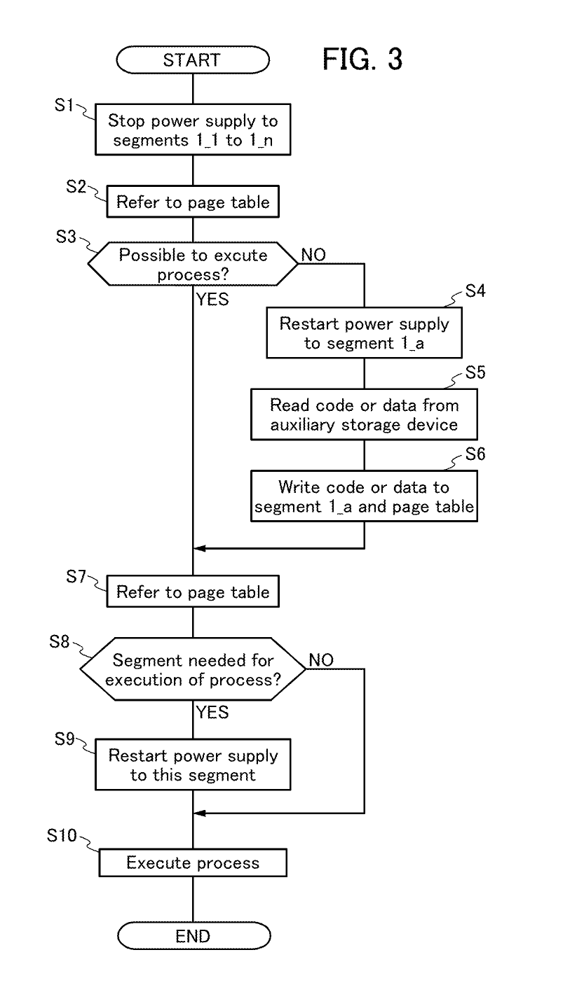

### <1-1-1. First Operation Flow of Virtual Storage Management: FIG. 3>

The flow of virtual storage management in the memory management system illustrated in FIG. 1 will be described below with reference to FIG. 3.

First, the memory power supply control unit 2 stops power supply to the segments 1_1 to 1_{—}n (Step S1).

Next, the operating system (OS) looks up a page table corresponding to a process to be executed (Step S2).

Then, the operating system (OS) determines whether the process can be executed or not (Step S3). In other words, the operating system (OS) determines whether code or data necessary to execute the process is located in the physical address space or not.

When execution of the process is determined to be impossible, the memory power supply control unit 2 restarts power supply to the segment 1_{—}a that has a physical address at which new code or data is located (Step S4). After that, the operating system (OS) reads the needed code and data from an auxiliary storage device (Step S5). Then, the memory management unit 3 locates the readout code and data at any of the plurality of physical addresses in the segment 1_{—}a, and the operating system (OS) writes a newly added correspondence between the virtual address and the physical address into the page table (Step S6).

Next, the operating system (OS) again looks up the page table corresponding to the process to be executed (Step S7).

Subsequently, the operating system (OS) determines a segment necessary to execute the process (Step S8). In other words, the operating system (OS) determines whether each of the segments 1_1 to 1_{—}n includes a physical address used in the process or not.

Then, the memory power supply control unit 2 restarts power supply to a segment that is determined to be necessary to execute the process (Step S9). Note that power supply to the other segments is kept stopped.

In the flow illustrated in FIG. 3, through the above steps, the operating system (OS) executes the process (Step S10).

In the flow illustrated in FIG. 3, power is supplied to a needed segment while the process is executed. In other words, a segment that is not required to execute the process is not supplied with power during execution of the process. Thus, power for executing the process can be reduced.

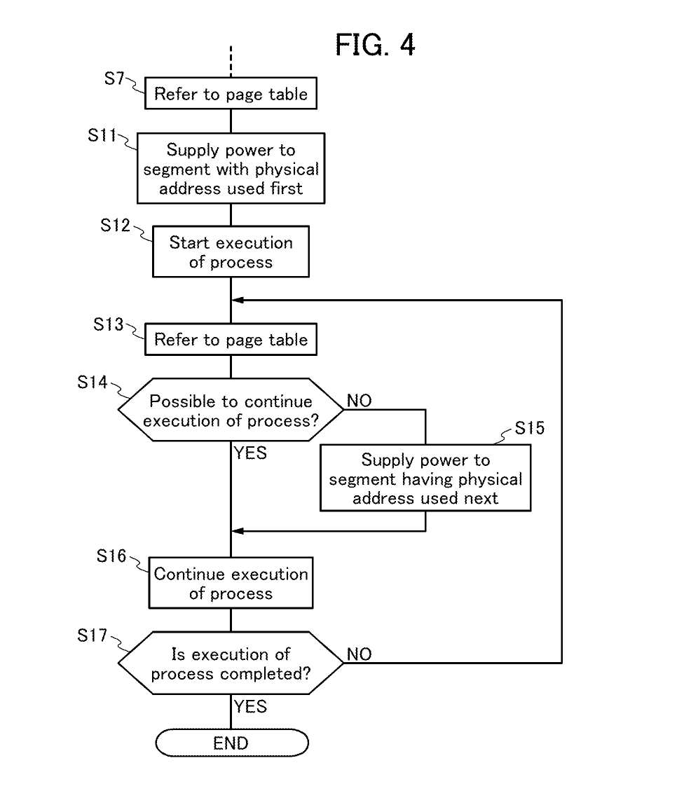

### <1-1-2. Second Operation Flow of Virtual Storage Management: FIG. 4>

The description is made below with reference to FIG. 4 on the flow of virtual storage management, which is different from that illustrated in FIG. 3. Specifically, the flow in FIG. 4 differs from the flow in FIG. 3 in that power is supplied only to one of the segments 1_1 to 1_{—}n during execution of the process (in the flow in FIG. 3, power is supplied to all the segments necessary to execute the process during execution of the process). Note that the steps prior to Step S7 are omitted in FIG. 4.

In the flow illustrated in FIG. 4, operation up to Step S7 is performed in a manner similar to that in the flow in FIG. 3.

Next, power is supplied only to a segment having a physical address that is used first when a process is executed (Step S11).

Then, the operating system (OS) starts execution of the process (Step S12).

Next, the operating system (OS) looks up a page table corresponding to the executed process (Step S13).

Then, the operating system (OS) determines whether the process can be continued or not (Step S14). In other words, the operating system (OS) determines whether code and data necessary to continue execution of the process are located or not in the segment to which power is actually being supplied.

When continuation of the process execution is determined to be impossible, the memory power supply control unit 2 restarts power supply to a segment that has the physical address used for continuing execution of the process, and stops power supply to the segment to which power has been supplied so far (Step S15).

Then, the operating system (OS) continues execution of the process (Step S16).

In the flow illustrated in FIG. 4, Steps S13 to S16 are repeated until execution of the process is completed (Step S17).

In the flow in FIG. 4, during execution of the process, power is supplied to any one of the segments 1_1 to 1_{—}n while segments to which power is supplied are switched. In other words, power is not supplied to (n−1) segments during execution of the process. Thus, power necessary to execute the process can be further reduced more than the power in the flow of FIG. 3. On the other hand, operation delay of the memory management system can be smaller in the flow of FIG. 3 than in the flow of FIG. 4.

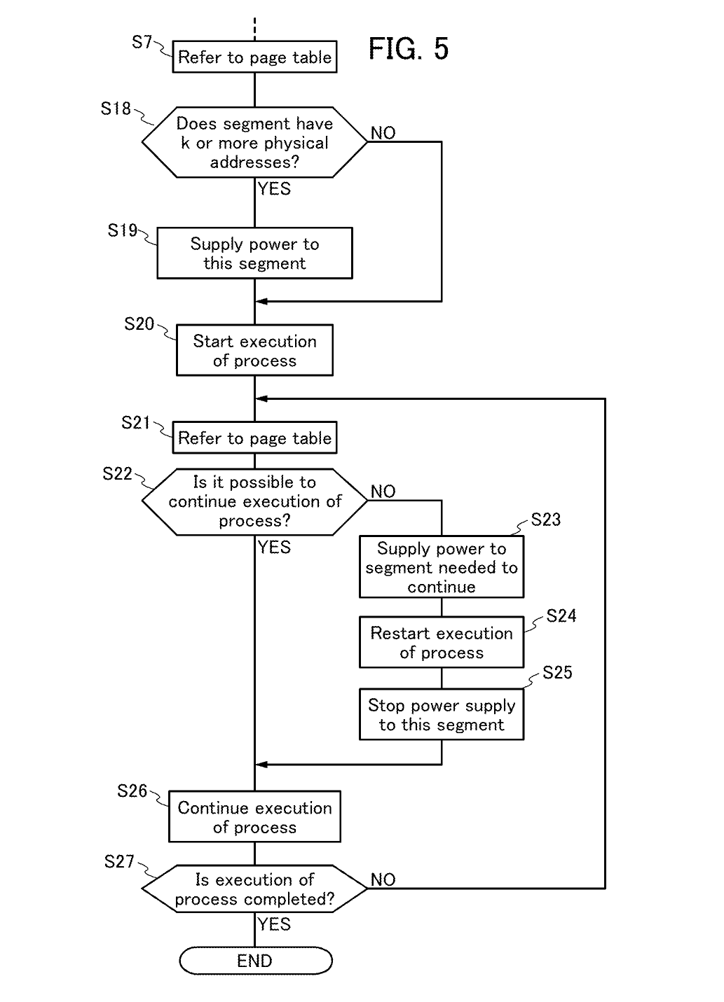

### <1-1-3. Third Operation Flow of Virtual Storage Management: FIG. 5>

The description is made below with reference to FIG. 5 on the flow of virtual storage management, which is different from those illustrated in FIGS. 3 and 4. Specifically, the flow in FIG. 5 differs from the flows in FIGS. 3 and 4 in that during execution of a process, power is supplied to some of a plurality of segments that are determined to be necessary to execute the process. Note that the steps prior to Step S7 are omitted in FIG. 5.

In the flow illustrated in FIG. 5, operation up to Step S7 is performed in a manner similar to that in the flow in FIG. 3.

Next, the operating system (OS) determines whether or not each of the segments 1_1 to 1_{—}n has k or more physical addresses (k is a natural number of 2 or more) used in the process (Step S18). Note that in the case where k=1, the flow in FIG. 5 is the same as that in FIG. 3.

Then, the memory power supply control unit 2 restarts power supply to the segment that has k or more physical addresses used in the process (Step S19). Note that power supply to segments that include less than k addresses used in the process is kept stopped.

Next, the operating system (OS) starts execution of the process (Step S20).

Subsequently, the operating system (OS) looks up a page table corresponding to the executed process (Step S21).

Then, the operating system (OS) determines whether the process can be continued or not (Step S22). In other words, the operating system (OS) determines whether code and data necessary to continue the process are located or not in the segment to which power is actually being supplied.

When continuation of the process is determined to be impossible, the memory power supply control unit 2 restarts power supply to a segment that has a physical address used for continuing the process (Step S23). After that, the operating system (OS) continues execution of the process (Step S24). Then, the memory power supply control unit 2 stops power supply to the segment where power supply has been newly restarted (Step S25).

Next, the operating system (OS) continues execution of the process (Step S26).

In the flow illustrated in FIG. 5, Steps S21 to S26 are repeated until execution of the process is completed (Step S27).

In the flow in FIG. 5, power supply to each of the segments 1_1 to 1_{—}n is classified into three types. Specifically, a segment having a large number of physical addresses used in a process is supplied with power while the process is executed; a segment having a small number of physical addresses used in the process is temporarily supplied with power during execution of the process; and a segment that does not have a physical address used in the process is not supplied with power during execution of the process. Thus, power necessary to execute the process can be further reduced more than the power in the flow of FIG. 3. Further, operation delay of the memory management system can be smaller in the flow of FIG. 5 than in the flow of FIG. 4.

### <1-1-4. Variations of Flow of Virtual Storage Management>

The virtual storage management in the memory management system, which is described with reference to FIGS. 3 to 5, can be changed as appropriate.

For example, before Step S2 in FIG. 3, a step in which the operating system (OS) looks up a cache for the page table may be added, thereby increasing the operation speed of the memory management system in the case where execution of the process is determined to be possible when the operating system (OS) looks up the cache. In this case, a new correspondence between the virtual address and the physical address is written into the cache in Step S6. Moreover, a step in which the operating system (OS) looks up a cache for the page table may be added before Step S7, S13, or S21.

In Step S4 in FIG. 3, the memory power supply control unit 2 may restart power supply to a plurality of segments instead of to one segment 1_{—}a. In other words, selection of segments where power supply is to be restarted can be changed as appropriate depending on the volume of data and code that are newly read from the auxiliary storage device.

Step S8, S14, or S22 may be performed before Step S4 in FIG. 3, in which case the memory management unit 3 can locate the readout code or data preferentially at a physical address included in a segment that is determined in advance to be necessary to execute a process or to continue execution of the process. Thus, the number of segments that need to be supplied with power for executing the process can be reduced, so that power consumption can be reduced.

### <1-2. Structure Example of Nonvolatile Memory 1>

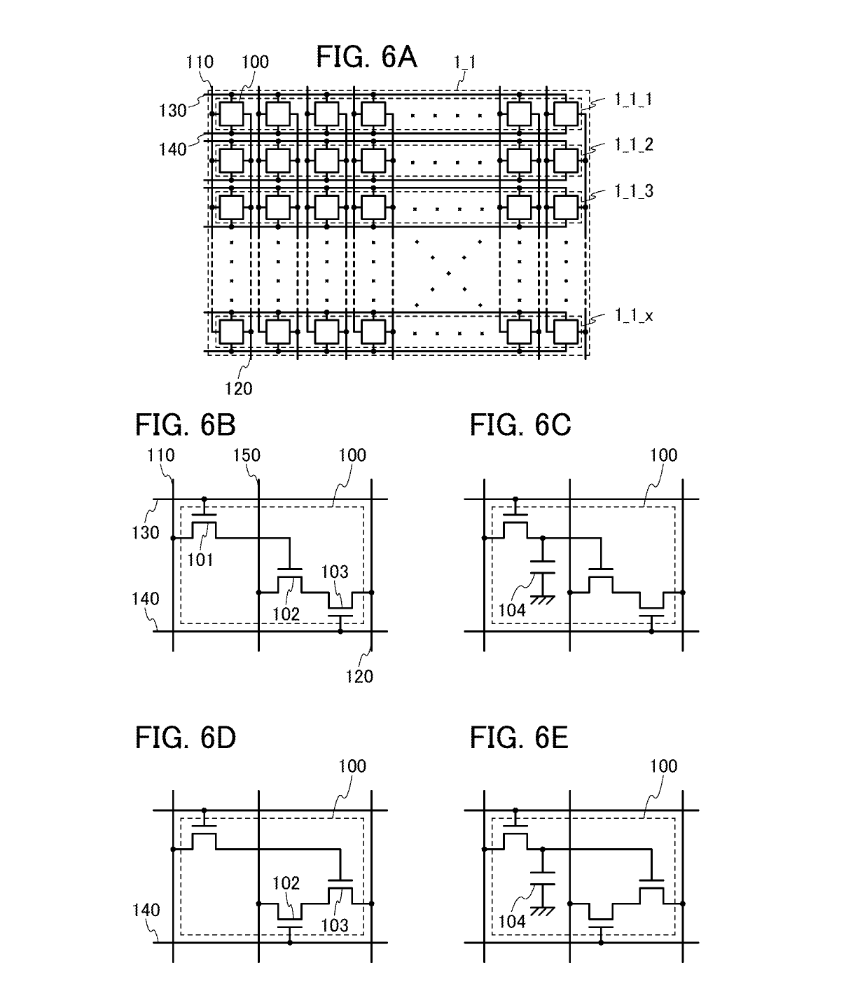

FIG. 6A illustrates an example of the structure of the segment 1_1 included in the nonvolatile memory 1 illustrated in FIG. 1. The segment 1_1 illustrated in FIG. 6A includes a plurality of memory cells 100 arranged in a matrix; a plurality of input bit lines 110 each of which is electrically connected to all memory cells 100 in a corresponding one column; a plurality of output bit lines 120 each of which is electrically connected to all memory cells 100 in a corresponding one column; a plurality of input word lines 130 each of which is electrically connected to all memory cells 100 in a corresponding one row; and a plurality of output word lines 140 each of which is electrically connected to all memory cells 100 in a corresponding one row.

Each of a plurality of physical addresses 1_1_1 to 1_1_{—}x consists of a plurality of memory cells 100 in a corresponding one row. That is, the input bit line 110 and the output bit line 120 are electrically connected to one of the plurality of memory cells 100 in each of the plurality of physical addresses 1_1_1 to 1_1_{—}x. The input word line 130 and the output word line 140 are electrically connected to all the memory cells 100 in one of the plurality of physical addresses 1_1_1 to 1_1_{—}x.

In the segment 1_1 illustrated in FIG. 6A, all the plurality of input bit lines 110 constitute an input bus, and all the plurality of output bit lines 120 constitute an output bus.

In the segment 1_1 illustrated in FIG. 6A, when a selection signal is supplied to one of the plurality of input word lines 130, new code or data is located at a physical address including a plurality of memory cells 100 electrically connected to the input word line 130. Moreover, in the segment 1_1 illustrated in FIG. 6A, when a selection signal is supplied to one of the plurality of output word lines 140, code or data located at a physical address including a plurality of memory cells 100 electrically connected to the output word line 140 is read.

Note that the structure of the segment 1_1 included in the nonvolatile memory 1 in FIG. 1 is not limited to that illustrated in FIG. 6A and can be a structure of various kinds of nonvolatile memory. For example, depending on the structure of the memory cell 100, one wiring can be used as the input bit line and the output bit line and/or one wiring can be used as the input word line and the output word line. Further, a wiring that is not illustrated in FIG. 6A can be additionally used.

### <1-2-1. Configuration Examples of Memory Cell 100>

FIGS. 6B to 6E are circuit diagrams each illustrating an example of the configuration of the memory cell 100 illustrated in FIG. 6A. In the memory cell 100 illustrated in FIGS. 6B to 6E, information is stored at a node that becomes floating when a transistor in which a channel is formed in an oxide semiconductor layer is turned off. Here, the transistor has extremely low off-state current; accordingly, the memory cell in which information is stored at the node that becomes floating when the transistor is turned off functions as a nonvolatile memory cell.

The memory cell 100 illustrated in FIG. 6B includes a transistor 101, a transistor 102, and a transistor 103. A gate of the transistor 101 is electrically connected to the input word line 130. One of a source and a drain of the transistor 101 is electrically connected to the input bit line 110. A gate of the transistor 102 is electrically connected to the other of the source and the drain of the transistor 101. One of a source and a drain of the transistor 102 is electrically connected to a reference potential line 150. A gate of the transistor 103 is electrically connected to the output word line 140. One of a source and a drain of the transistor 103 is electrically connected to the other of the source and the drain of the transistor 102. The other of the source and the drain of the transistor 103 is electrically connected to the output bit line 120. Note that the transistor 101 included in the memory cell 100 illustrated in FIG. 6B is a transistor in which a channel is formed in an oxide semiconductor layer.

The input word line 130 is supplied with a potential for turning on the transistor 101 as a selection signal, and supplied with a potential for turning off the transistor 101 as a non-selection signal. The output word line 140 is supplied with a potential for turning on the transistor 103 as a selection signal, and supplied with a potential for turning off the transistor 103 as a non-selection signal. The reference potential line 150 is supplied with a specific fixed potential.

In the memory cell 100 illustrated in FIG. 6B, 1-bit information can be stored at a node where the other of the source and the drain of the transistor 101 and the gate of the transistor 102 are electrically connected to each other. The stored information can be detected by judging the state (on/off state) of the transistor 102. Examples of a method of detecting the information are a method in which the potential of the output bit line 120 is detected while a voltage divider is configured by including the transistor 102, and the output bit line 120, and a method in which a predetermined potential is applied to the output bit line 120 in advance to detect whether the potential of the output bit line 120 is changed or not.

By detecting 1-bit information stored in each of a plurality of memory cells forming a physical address, code or data located at the physical address can be read.

Note that here, the memory cell 100 is described as a memory cell that can store 1-bit (binary) information. Alternatively, the memory cell 100 can be a memory cell capable of storing multi-bit (multi-level) information, thereby achieving a reduction in the circuit area and/or an increase in capacity of the nonvolatile memory 1.

As illustrated in FIG. 6C, a capacitor 104 can be added to the memory cell 100 in FIG. 6B so that one electrode of the capacitor 104 is electrically connected to the other of the source and the drain of the transistor 101 and the other electrode of the capacitor 104 is grounded. This configuration can improve the data retention of the memory cell 100.

As illustrated in FIG. 6D, the component to which the gate of the transistor 102 is connected and the component to which the gate of the transistor 103 is connected in the memory cell 100 in FIG. 6B can interchange each other. In this case, the output word line 140 is supplied with a potential for turning on the transistor 102 when code or data located at a physical address including the memory cell 100 is read, and is supplied with a potential for turning off the transistor 102 in the other periods.

As illustrated in FIG. 6E, the capacitor 104 can be added to the memory cell 100 in FIG. 6D.

The transistor 101 is preferably a transistor in which a channel is formed in an oxide semiconductor layer. The off-state current of the transistor in which a channel is formed in an oxide semiconductor layer is extremely low. For this reason, the use of the transistor in which a channel is formed in an oxide semiconductor layer as the transistor 101 improves the data retention of the memory cell 100 and easily allows the memory cell 100 to store multi-bit (multi-level) data.

When the transistors 102 and 103 as well as the transistor 101 are transistors in which a channel is formed in an oxide semiconductor layer, the transistors 101 to 103 can be fabricated through the same process. When the transistors 102 and 103 are transistors with higher mobility than a transistor in which a channel is formed in an oxide semiconductor layer (e.g., when the transistors 102 and 103 are transistors in which a channel is formed in a crystalline silicon layer or a compound semiconductor layer), the speed of reading the code or data can be increased.

Note that the structure of the segment 1_1 included in the nonvolatile memory 1 is not limited to that illustrated in FIG. 6A. For example, the segment 1_1 can have a structure in which charge held at a node that becomes floating when the transistor 101 is turned off corresponds to 1-bit information, that is, a structure of DRAM (note that DRAM is non-volatilized when a transistor in which a channel is formed in an oxide semiconductor layer is used as a transistor provided in a memory cell). In this case, some of the various wirings illustrated in FIG. 6A are not necessary, and the structure of the nonvolatile memory 1 can be simplified.

### <1-2-2. Structure Example of Memory Cell 100>

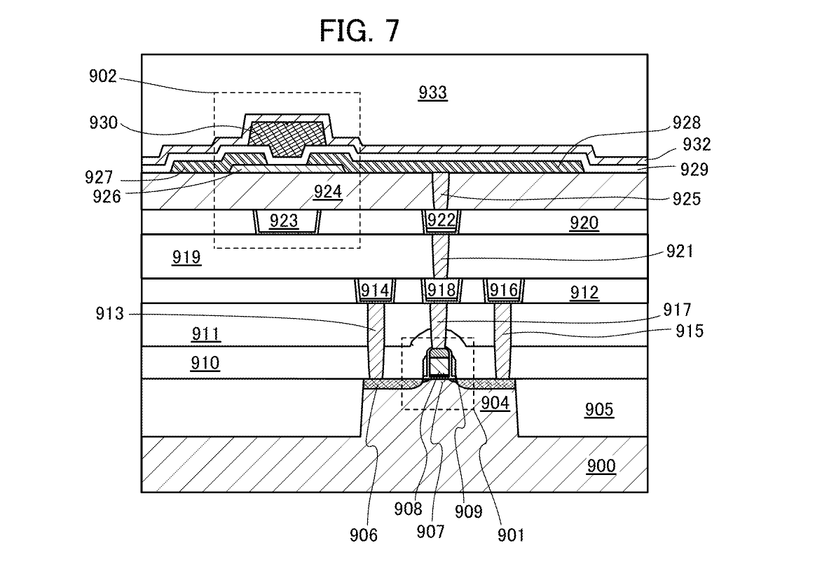

FIG. 7 illustrates an example of the structure of the memory cell 100 including a transistor 902 in which a channel is formed in an oxide semiconductor layer and a transistor 901 in which a channel is formed in a single crystal silicon wafer. Note that the transistor 902 can be used as the transistor 101 illustrated in FIG. 6B and the transistor 901 can be used as the transistor 102 illustrated in FIG. 6B, for example.

Note that a semiconductor material such as germanium, silicon germanium, or single crystal silicon carbide as well as silicon may be used for the transistor 901. A transistor including silicon can be formed using a silicon thin film formed by an SOI method or a silicon thin film formed by vapor deposition, for example; in this case, a glass substrate formed by a fusion process or a float process, a quartz substrate, a semiconductor substrate, a ceramic substrate, or the like can be used as a substrate. In the case where a glass substrate is used and the temperature of heat treatment to be performed later is high, it is preferable to use a glass substrate with a strain point of 730° C. or higher

In FIG. 7, the transistor 901 using a single crystal silicon wafer is formed, and the transistor 902 using an oxide semiconductor is formed above the transistor 901.

The transistor 901 formed using a substrate 900 containing a semiconductor material can be either an n-channel transistor (nMOSFET) or a p-channel transistor (pMOSFET). In FIG. 7, the transistor 901 is electrically isolated from other elements by a shallow trench isolation (STI) 905. The use of the STI 905 can reduce generation of a bird's beak, which is caused by a LOCOS element isolation method, in an element isolation region and can reduce the size of the element isolation region. On the other hand, in a semiconductor device that is not required to be structurally miniaturized or downsized, the STI 905 is not necessarily formed and an element isolation means such as LOCOS can be used. In the substrate 900 where the transistor 901 is formed, a well 904 to which an impurity imparting conductivity, such as boron, phosphorus, or arsenic, is added is formed.

The transistor 901 in FIG. 7 includes a channel formation region in the substrate 900, impurity regions 906 (also referred to as a source region and a drain region) provided such that the channel formation region is placed therebetween, a gate insulating film 907 over the channel formation region, and a gate electrode layer 908 provided over the gate insulating film 907 to overlap the channel formation region. The gate electrode layer 908 can have a stacked structure of a gate electrode layer including a first material for increasing processing accuracy and a gate electrode layer including a second material for decreasing the resistance as a wiring. For example, the gate electrode layer 908 can have a stacked structure of crystalline silicon to which an impurity imparting conductivity, such as phosphorus, is added and nickel silicide. Note that the structure is not limited to this, and materials, the number of stacked layers, the shape, or the like can be adjusted as appropriate depending on required specifications.

Note that the transistor 901 illustrated in FIG. 7 may be a fin-type transistor. In a fin-type structure, part of a semiconductor substrate is processed into a plate-shaped protrusion, and a gate electrode layer is provided to cross the protrusion in the longitudinal direction. The gate electrode layer covers an upper surface and side surfaces of the protrusion with a gate insulating film placed between the gate electrode layer and the protrusion. With the transistor 901 having a fin-type structure, the channel width can be reduced to achieve higher integration of transistors. Moreover, a larger amount of current can flow through the transistor and the control efficiency can be increased, so that the off-state current and threshold voltage of the transistor can be reduced.

Contact plugs 913 and 915 are connected to the impurity regions 906 in the substrate 900. Here, the contact plugs 913 and 915 also function as a source electrode and a drain electrode of the transistor 901. In addition, impurity regions that are different from the impurity regions 906 are provided between the impurity regions 906 and the channel formation region. The impurity regions function as LDD regions or extension regions for controlling the distribution of electric fields in the vicinity of the channel formation region, depending on the concentration of an impurity introduced thereto. Sidewall insulating films 909 are provided on side surfaces of the gate electrode layer 908 with an insulating film placed therebetween. By using this insulating film and the sidewall insulating films 909, the LDD regions or extension regions can be formed.

The transistor 901 is covered with an insulating film 910. The insulating film 910 can function as a protective film and can prevent impurities from entering the channel formation region from the outside. With the insulating film 910 formed by CVD using silicon nitride or the like, hydrogenation can be performed by heat treatment in the case where single crystal silicon is used for the channel formation region. When an insulating film having tensile stress or compressive stress is used as the insulating film 910, distortion can be provided to the semiconductor material used for the channel formation region. By application of tensile stress to a silicon material used for the channel formation region of an n-channel transistor or application of compressive stress to a silicon material used for the channel formation region of a p-channel transistor, the field-effect mobility of the transistor can be increased.

An insulating film 911 is provided over the insulating film 910, and a surface of the insulating film 911 is planarized by CMP. Consequently, element layers can be stacked with high accuracy above the level at which the transistor 901 is formed.

The level at which the transistor 902 whose channel is formed in an oxide semiconductor layer is formed is placed above the level of the transistor 901. The transistor 902 is a top-gate transistor. The transistor 902 includes a source electrode layer 927 and a drain electrode layer 928 in contact with side surfaces and an upper surface of an oxide semiconductor film 926, and includes a gate electrode layer 930 over a gate insulating film 929 placed over the oxide semiconductor film 926, the source electrode layer 927, and the drain electrode layer 928. Insulating films 932 and 933 are formed to cover the transistor 902. Here, a method of fabricating the transistor 902 will be described below.

The oxide semiconductor film 926 is formed over the insulating film 924. The insulating film 924 can be formed using an inorganic insulating film of silicon oxide, silicon nitride, silicon nitride oxide, silicon oxynitride, aluminum oxide, aluminum nitride, aluminum nitride oxide, or the like. In particular, the insulating film 924 is preferably formed using a material with a low dielectric constant (a low-k material) because capacitance due to overlap of electrodes or wirings can be sufficiently reduced. Note that the insulating film 924 may be a porous insulating film containing any of the above materials. Since the porous insulating film has lower dielectric constant than a dense insulating film, parasitic capacitance due to electrodes or wirings can be further reduced. For example, the insulating film 924 may be a stack of a silicon oxide film with a thickness of about 300 nm on a 50-nm-thick aluminum oxide film.

The oxide semiconductor film 926 can be formed by processing an oxide semiconductor film formed over the insulating film 924 into a desired shape. The thickness of the oxide semiconductor film is 2 nm to 200 nm, preferably 3 nm to 50 nm, more preferably 3 nm to 20 nm. The oxide semiconductor film is formed by sputtering using an oxide semiconductor target. Moreover, the oxide semiconductor film can be formed by sputtering under a rare gas (e.g., argon) atmosphere, an oxygen atmosphere, or a mixed atmosphere of a rare gas (e.g., argon) and oxygen.

Note that before the oxide semiconductor film is formed by sputtering, dust on a surface of the insulating film 924 is preferably removed by reverse sputtering in which an argon gas is introduced and plasma is generated. The reverse sputtering refers to a method in which, without application of voltage to a target side, an RF power source is used for application of voltage to a substrate side in an argon atmosphere to generate plasma in the vicinity of the substrate to modify a surface. Note that instead of an argon atmosphere, a nitrogen atmosphere, a helium atmosphere, or the like may be used. Alternatively, an argon atmosphere to which oxygen, nitrous oxide, or the like is added may be used. Further alternatively, an argon atmosphere to which chlorine, carbon tetrafluoride, or the like is added may be used.

For example, an In—Ga—Zn-based oxide semiconductor thin film that has a thickness of 30 nm and is obtained by sputtering using a target including indium (In), gallium (Ga), and zinc (Zn) is used as the oxide semiconductor film. As the target, it is preferable to use a target having an atomic ratio of In:Ga:Zn=1:1:1, 4:2:3, 3:1:2, 1:1:2, 2:1:3, or 3:1:4. The filling rate of the target including In, Ga, and Zn is 90% or higher and 100% or lower, and preferably 95% or higher and lower than 100%. With the use of the target with high filling rate, a dense oxide semiconductor film is formed.

In the case where an In—Zn-based material is used for the oxide semiconductor film, a target to be used has a composition ratio of In:Zn=50:1 to 1:2 in an atomic ratio (In₂O₃:ZnO=25:1 to 1:4 in a molar ratio), preferably In:Zn=20:1 to 1:1 in an atomic ratio (In₂O₃:ZnO=10:1 to 1:2 in a molar ratio), further preferably In:Zn=15:1 to 1.5:1 in an atomic ratio (In₂O₃:ZnO=15:2 to 3:4 in a molar ratio). For example, in a target used for formation of an In—Zn-based oxide semiconductor with an atomic ratio of In:Zn:O=X:Y:Z, the relation of Z>1.5X+Y is satisfied. The mobility can be improved by keeping the ratio of Zn within the above range.

In the case where an In—Sn—Zn-based oxide semiconductor film is formed as the oxide semiconductor film by sputtering, it is preferable to use an In—Sn—Zn—O target having an atomic ratio of In:Sn:Zn=1:1:1, 2:1:3, 1:2:2, or 20:45:35.

In this embodiment, the oxide semiconductor film may be formed in such a manner that the substrate is held in a treatment chamber kept in a reduced pressure state, a sputtering gas from which hydrogen and moisture are removed is introduced while moisture remaining in the treatment chamber is removed, and the above-described target is used. The substrate temperature during the film formation may be 100° C. to 600° C., preferably 200° C. to 400° C. By forming the oxide semiconductor film while the substrate is heated, the concentration of impurities included in the formed oxide semiconductor film can be reduced. In addition, damage by sputtering can be reduced. In order to remove remaining moisture in the treatment chamber, an entrapment vacuum pump is preferably used. For example, a cryopump, an ion pump, or a titanium sublimation pump is preferably used. The evacuation unit may be a turbo pump provided with a cold trap. In the treatment chamber which is evacuated with the cryopump, for example, a hydrogen atom, a compound containing a hydrogen atom, such as water (H₂O), and the like are removed, whereby the impurity concentration in the oxide semiconductor film formed in the treatment chamber can be reduced.

As one example of the deposition conditions, the distance between the substrate and the target is 100 mm, the pressure is 0.6 Pa, the direct current (DC) power is 0.5 kW, and the atmosphere is an oxygen atmosphere (the proportion of the oxygen flow rate is 100%). Note that a pulsed direct current (DC) power source is preferably used because dust generated in deposition can be reduced and the film thickness can be made uniform.

When the leakage rate of the treatment chamber of the sputtering apparatus is set to 1×10⁻¹⁰ Pa·m³/s or less, entry of impurities such as an alkali metal or a hydride into the oxide semiconductor film that is formed by sputtering can be reduced. Further, with the use of an entrapment vacuum pump as an exhaustion system, counter flow of impurities such as an alkali metal, hydrogen atoms, hydrogen molecules, water, or a hydride from the exhaustion system can be reduced.

When the purity of the target is set to 99.99% or higher, an alkali metal, hydrogen atoms, hydrogen molecules, water, a hydroxyl group, a hydride, or the like mixed into the oxide semiconductor film can be reduced. In addition, when the above target is used, the concentration of an alkali metal such as lithium, sodium, or potassium can be reduced in the oxide semiconductor film.

In order that the oxide semiconductor film contains hydrogen, a hydroxyl group, and moisture as little as possible, it is preferable that impurities such as moisture or hydrogen that are adsorbed on the substrate 900 be desorbed and exhausted by preheating of the substrate 900 over which the insulating film 924 is formed in a preheating chamber of a sputtering apparatus, as pretreatment for deposition. The temperature for the preheating is 100° C. to 400° C., preferably 150° C. to 300° C. As an evacuation unit provided in the preheating chamber, a cryopump is preferably used. Note that this preheating treatment can be omitted.

Note that etching for forming the oxide semiconductor film 926 may be dry etching, wet etching, or both dry etching and wet etching. As an etching gas used for dry etching, it is preferable to use a gas containing chlorine (a chlorine-based gas such as chlorine (Cl₂), boron trichloride (BCl₃), silicon tetrachloride (SiCl₄), or carbon tetrachloride (CCl₄)). Alternatively, it is possible to use a gas containing fluorine (a fluorine-based gas such as carbon tetrafluoride (CF₄), sulfur hexafluoride (SF₆), nitrogen trifluoride (NF₃), or trifluoromethane (CHF₃)), hydrogen bromide (HBr), oxygen (O₂), any of these gases to which a rare gas such as helium (He) or argon (Ar) is added, or the like.

As the dry etching method, a parallel plate RIE (reactive ion etching) method or an ICP (inductively coupled plasma) etching method can be used. In order to etch the film into a desired shape, the etching conditions (e.g., the electric power applied to a coiled electrode, the electric power applied to an electrode on the substrate side, and the electrode temperature on the substrate side) are adjusted as appropriate.

A resist mask used for forming the oxide semiconductor film 926 may be formed by an inkjet method. Formation of the resist mask by an inkjet method needs no photomask; thus, fabrication cost can be reduced.

Note that it is preferable that reverse sputtering is performed before the formation of a conductive film in a subsequent step so that a resist residue and the like that attach onto surfaces of the oxide semiconductor film 926 and the insulating film 924 are removed.

Note that the oxide semiconductor film formed by sputtering or the like sometimes contains a large amount of moisture or hydrogen (including a hydroxyl group) as impurities. Moisture or hydrogen easily forms donor levels and thus serves as impurities in the oxide semiconductor. For this reason, impurities such as moisture and hydrogen in the oxide semiconductor film are preferably reduced (the oxide semiconductor film is preferably dehydrated or dehydrogenated). For example, the oxide semiconductor film 926 can be subjected to heat treatment in a reduced-pressure atmosphere, an inert gas atmosphere of nitrogen, a rare gas, or the like, an oxygen gas atmosphere, or an ultra-dry air atmosphere (with a moisture content of 20 ppm (−55° C. by conversion into a dew point) or less, preferably 1 ppm or less, further preferably 10 ppb or less, in the case where the measurement is performed by a dew point meter of a cavity ring down laser spectroscopy (CRDS) system).

By performing heat treatment on the oxide semiconductor film 926, moisture or hydrogen in the oxide semiconductor film 926 can be eliminated. Specifically, heat treatment may be performed at a temperature higher than or equal to 250° C. and lower than or equal to 750° C., preferably higher than or equal to 400° C. and lower than the strain point of the substrate. For example, heat treatment may be performed at 500° C. for approximately 3 to 6 minutes. When RTA (rapid thermal annealing) is used for the heat treatment, dehydration or dehydrogenation can be performed in a short time; thus, treatment can be performed even at a temperature higher than the strain point of a glass substrate.

For the heat treatment, an electric furnace which is one of heat treatment apparatuses is favorably used.

The heat treatment apparatus is not limited to an electric furnace, and may have a device for heating an object by heat conduction or heat radiation from a heating element such as a resistance heating element. For example, an RTA apparatus such as a GRTA (gas rapid thermal annealing) apparatus or an LRTA (lamp rapid thermal annealing) apparatus can be used. An LRTA apparatus is an apparatus for heating an object by radiation of light (an electromagnetic wave) emitted from a lamp such as a halogen lamp, a metal halide lamp, a xenon arc lamp, a carbon arc lamp, a high pressure sodium lamp, or a high pressure mercury lamp. A GRTA apparatus is an apparatus for heat treatment using a high-temperature gas. As the gas, an inert gas which does not react with an object by heat treatment, like nitrogen or a rare gas such as argon is used.

In the heat treatment, it is preferable that moisture, hydrogen, and the like be not contained in nitrogen or a rare gas such as helium, neon, or argon. Alternatively, the purity of nitrogen or a rare gas such as helium, neon, or argon which is introduced into the heat treatment apparatus is preferably 6N (99.9999%) or higher, more preferably 7N (99.99999%) or higher (i.e., the impurity concentration is preferably 1 ppm or lower, more preferably 0.1 ppm or lower).

Through the above-described steps, the concentration of hydrogen in the oxide semiconductor film 926 can be reduced and the oxide semiconductor film 926 is highly purified. Thus, the oxide semiconductor film can be stable. In addition, by using the oxide semiconductor film in which the hydrogen concentration is reduced and the purity is improved, it is possible to fabricate a transistor with high withstand voltage and extremely low off-state current. The above heat treatment can be performed at any time after the oxide semiconductor film is formed.

Next, the source electrode layer 927 and the drain electrode layer 928 are formed by a photolithography process. Specifically, the source electrode layer 927 and the drain electrode layer 928 can be formed in such a manner that a conductive film is formed over the insulating film 924 by sputtering or vacuum evaporation and then processed (patterned) into a predetermined shape.

Note that the materials and etching conditions are adjusted as appropriate so that the oxide semiconductor film 926 is not removed as much as possible in etching of the conductive film. Depending on the etching conditions, an exposed portion of the oxide semiconductor film 926 is partially etched and thus a groove (a recessed portion) is formed in some cases.

For example, in the case where a tungsten film is used as the conductive film to be the source electrode layer 927 and the drain electrode layer 928, wet etching can be selectively performed on the conductive film using a solution containing ammonia and hydrogen peroxide water (an ammonia hydrogen peroxide mixture). Specifically, as the ammonia hydrogen peroxide mixture, a solution in which 31 wt % hydrogen peroxide water, 28 wt % ammonia water, and water are mixed at a volume ratio of 5:2:2 is favorably used. Alternatively, dry etching may be performed on the conductive film with the use of a gas containing carbon tetrafluoride (CF₄), chlorine (Cl₂), or oxygen.

In order to reduce the number of photomasks and steps in a photolithography process, etching may be performed with the use of a resist mask formed using a multi-tone mask which is a light-exposure mask through which light is transmitted so as to have a plurality of intensities. A resist mask formed using a multi-tone mask has a plurality of thicknesses and can be changed in shape by ashing; thus, the resist mask can be used in a plurality of etching steps for processing films into different patterns. In other words, a resist mask corresponding to at least two kinds of different patterns can be formed by one multi-tone mask. As a result, the number of light-exposure masks can be reduced and the number of corresponding photolithography processes can also be reduced, whereby the fabrication process can be simplified.

Further, oxide conductive films functioning as a source region and a drain region may be provided between the oxide semiconductor film 926 and the source and drain electrode layers 927 and 928. The material of the oxide conductive film preferably contains zinc oxide as a component and preferably does not contain indium oxide. For such an oxide conductive film, zinc oxide, zinc aluminum oxide, zinc aluminum oxynitride, gallium zinc oxide, or the like can be used.

For example, in the case where the oxide conductive films are formed, etching for forming the oxide conductive films and etching for forming the source electrode layer 927 and the drain electrode layer 928 may be performed concurrently.

By providing the oxide conductive films functioning as the source and drain regions, the resistance between the oxide semiconductor film 926 and the source and drain electrode layers 927 and 928 can be lowered, so that the transistor can operate at high speed. In addition, with provision of the oxide conductive films functioning as the source and drain regions, the withstand voltage of the transistor can be increased.

Next, plasma treatment may be performed using a gas such as N₂O, N₂, or Ar. By this plasma treatment, water or the like attached onto an exposed surface of the oxide semiconductor film is removed. Plasma treatment may be performed using a mixture gas of oxygen and argon as well.

After the plasma treatment, the gate insulating film 929 is formed to cover the source and drain electrode layers 927 and 928 and the oxide semiconductor film 926. Then, over the gate insulating film 929, the gate electrode layer 930 is formed to overlap the oxide semiconductor film 926.

After the gate insulating film 929 is formed, heat treatment may be performed. The heat treatment is performed in a nitrogen atmosphere, ultra-dry air, or a rare gas (e.g., argon or helium) atmosphere preferably at 200° C. to 400° C., and for example at 250° C. to 350° C. It is preferable that the water content in the gas be 20 ppm or less, preferably 1 ppm or less, further preferably 10 ppb or less. For example, heat treatment is performed at 250° C. for 1 hour in a nitrogen atmosphere. Alternatively, RTA treatment for a short time at a high temperature may be performed before the formation of the source and drain electrode layers 927 and 928 in a manner similar to that of the heat treatment performed on the oxide semiconductor film for reduction of moisture or hydrogen. Even when oxygen vacancies are generated in the oxide semiconductor film 926 by the previous heat treatment performed on the oxide semiconductor film 926, oxygen is supplied to the oxide semiconductor film 926 from the gate insulating film 929 by performing heat treatment after the gate insulating film 929 including oxygen is provided. By the supply of oxygen to the oxide semiconductor film 926, oxygen vacancies that serve as donors can be reduced in the oxide semiconductor film 926 and the stoichiometric composition can be recovered. As a result, the oxide semiconductor film 926 can be made to be substantially i-type and variation in electrical characteristics of the transistor due to oxygen vacancies can be reduced; thus, electrical characteristics can be improved. There is no particular limitation on the timing of this heat treatment as long as it is after the formation of the gate insulating film 929. When this heat treatment doubles as another step, the oxide semiconductor film 926 can be made to be substantially i-type without the increase in the number of steps.

Moreover, oxygen vacancies that serve as donors in the oxide semiconductor film 926 may be reduced by subjecting the oxide semiconductor film 926 to heat treatment in an oxygen atmosphere so that oxygen is added to the oxide semiconductor. The heat treatment is performed at a temperature of, for example, higher than or equal to 100° C. and lower than 350° C., preferably higher than or equal to 150° C. and lower than 250° C. It is preferable that an oxygen gas used for the heat treatment in an oxygen atmosphere do not include water, hydrogen, or the like. Alternatively, the purity of the oxygen gas which is introduced into the heat treatment apparatus is preferably 6N (99.9999%) or higher, more preferably 7N (99.99999%) or higher (i.e., the impurity concentration in the oxygen gas is preferably 1 ppm or lower, more preferably 0.1 ppm or lower).

Alternatively, oxygen may be added to the oxide semiconductor film 926 by ion implantation, ion doping, or the like to reduce oxygen vacancies serving as donors. For example, oxygen that is made into a plasma state with a microwave at 2.45 GHz may be added to the oxide semiconductor film 926.

The gate electrode layer 930 can be formed in such a manner that a conductive film is formed over the gate insulating film 929 and then is processed (patterned) into a desired shape by etching.

The thickness of each of the gate electrode layer 930 is 10 nm to 400 nm, preferably 100 nm to 300 nm. Note that a resist mask may be formed by an inkjet method. Formation of the resist mask by an inkjet method needs no photomask; thus, fabrication cost can be reduced.

Through the above steps, the transistor 902 is formed.

Note that the transistor 902 is described as a single-gate transistor; if necessary, it is possible to fabricate a multi-gate transistor that includes a plurality of gate electrodes electrically connected to each other and thus includes a plurality of channel formation regions.

In the fabrication method described above, the source electrode layer 927 and the drain electrode layer 928 are formed after the oxide semiconductor film 926. Accordingly, as illustrated in FIG. 7, the source electrode layer 927 and the drain electrode layer 928 are formed over the oxide semiconductor film 926 in the transistor 902 obtained by the fabrication method. Alternatively, in the transistor 902, the source and drain electrode layers may be formed below the oxide semiconductor film 926, that is, between the oxide semiconductor film 926 and the insulating film 924.

Note that insulating films in contact with the oxide semiconductor film 926 may be formed using an insulating material containing an element that belongs to Group 13 and oxygen. Many of oxide semiconductor materials contain a Group 13 element, and an insulating material containing a Group 13 element is compatible with such an oxide semiconductor. Thus, when an insulating material containing a Group 13 element is used for the insulating film in contact with the oxide semiconductor film, the state of the interface between the oxide semiconductor film and the insulating film can be kept favorable.

An insulating material containing a Group 13 element is an insulating material containing one or more elements that belong to Group 13 of the periodic table. Examples of the insulating material containing a Group 13 element are gallium oxide, aluminum oxide, aluminum gallium oxide, and gallium aluminum oxide. Here, aluminum gallium oxide refers to a material in which the aluminum content is higher than the gallium content in atomic percent, and gallium aluminum oxide refers to a material in which the gallium content is higher than or equal to the aluminum content in atomic percent.

For example, when a material containing gallium oxide is used for an insulating film that is in contact with an oxide semiconductor film containing gallium, characteristics at the interface between the oxide semiconductor film and the insulating film can be kept favorable. For example, when the oxide semiconductor film and an insulating film containing gallium oxide are provided in contact with each other, pile up of hydrogen at the interface between the oxide semiconductor film and the insulating film can be reduced. Note that a similar effect can be obtained when an element in the same group as a constituent element of the oxide semiconductor is used in an insulating film. For example, it is effective to form an insulating film with the use of a material containing aluminum oxide. Note that water is less likely to permeate aluminum oxide, and it is therefore preferable to use a material containing aluminum oxide in terms of preventing entry of water to the oxide semiconductor film.

The insulating film that is in contact with the oxide semiconductor film 926 preferably contains oxygen in a proportion higher than the stoichiometric composition by heat treatment in an oxygen atmosphere, oxygen doping, or the like. Oxygen doping is addition of oxygen into a bulk. Note that the term “bulk” is used in order to clarify that oxygen is added not only to a surface of a thin film but also to the inside of the thin film. The term “oxygen doping” includes oxygen plasma doping in which oxygen that is made to be plasma is added to a bulk. The oxygen doping may be performed by ion implantation or ion doping.

By oxygen doping, an insulating film that includes a region where the proportion of oxygen is higher than that in the stoichiometric composition can be formed. When the insulating film including such a region is in contact with the oxide semiconductor film, excess oxygen in the insulating film is supplied to the oxide semiconductor film, and oxygen defects in the oxide semiconductor film or at the interface between the oxide semiconductor film and the insulating film are reduced. Thus, the oxide semiconductor film can be made to be an i-type or substantially i-type oxide semiconductor.

Note that the insulating film including a region where the proportion of oxygen is higher than that in the stoichiometric composition may be used as either the insulating film placed above the oxide semiconductor film 926 or the insulating film placed below the oxide semiconductor film 926 of the insulating films in contact with the oxide semiconductor film 926; however, it is preferable to use such an insulating film as both of the insulating films in contact with the oxide semiconductor film 926. The above-described effect can be enhanced with a structure where the insulating films including a region where the proportion of oxygen is higher than that in the stoichiometric composition are used as insulating films placed above and below the insulating films in contact with the oxide semiconductor film 926 so that the oxide semiconductor film 926 is sandwiched between the insulating films.

The insulating films placed above and below the oxide semiconductor film 926 may contain the same constituent elements or different constituent elements. The insulating film in contact with the oxide semiconductor film 926 may be a stack of insulating films each including a region where the proportion of oxygen is higher than that in the stoichiometric composition.

In FIG. 7, the transistor 902 has a top-gate structure. The transistor 902 includes a backgate electrode layer 923. The provision of the backgate electrode layer 923 allows the transistor 902 to obtain normally-off characteristics more easily. For example, when the potential of the backgate electrode layer 923 is set at GND or a fixed potential, the threshold voltage of the transistor 902 can shift further in a positive direction, which leads to the formation of a normally-off transistor.

In order to electrically connect the transistor 901 and the transistor 902 to form an electric circuit, one or more wiring layers for connecting these elements are stacked between levels.

In FIG. 7, one of the source and the drain of the transistor 901 is electrically connected to a wiring layer 914 through the contact plug 913. The other of the source and the drain of the transistor 901 is electrically connected to a wiring layer 916 through the contact plug 915. The gate of the transistor 901 is electrically connected to the drain electrode layer 928 of the transistor 902 through a contact plug 917, a wiring layer 918, a contact plug 921, a wiring layer 922, and a contact plug 925.

The wiring layers 914, 916, 918, and 922 and the backgate electrode layer 923 are embedded in insulating films. These wiring layers and the like are preferably formed using a low-resistance conductive material such as copper or aluminum. Alternatively, the wiring layers can be formed using graphene formed by CVD as a conductive material. Graphene is a one-atom thick sheet of sp²-bonded carbon molecules or a stack of 2 to 100 sheets of carbon molecules. Examples of a method of manufacturing such graphene are thermal CVD by which graphene is formed on a metal catalyst; and plasma CVD by which graphene is formed from methane, without using a catalyst, by plasma generated locally with ultraviolet light irradiation.

By using such a low-resistance conductive material, RC delay of signals transmitted through the wiring layers can be reduced. When copper is used for the wiring layers, a barrier film is formed in order to prevent copper from diffusing into the channel formation region. The barrier film can be a tantalum nitride film, a stack of a tantalum nitride film and a tantalum film, a titanium nitride film, or a stack of a titanium nitride film and a titanium film, for example, but is not limited to a film containing such materials as long as the film has a function of preventing diffusion of a wiring material and has adhesion to the wiring material, a base film, or the like. The barrier film may be formed as a layer that is independently formed, or may be formed in such a manner that a material of the barrier film is included in a wiring material and precipitated by heat treatment on the inner wall of an opening provided in an insulating film.

The insulating films 911, 912, 919, 920, and 933 can be formed using an insulator such as silicon oxide, silicon oxynitride, silicon nitride oxide, borophosphosilicate glass (BPSG), phosphosilicate glass (PSG), silicon oxide to which carbon is added (SiOC), silicon oxide to which fluorine is added (SiOF), tetraethylorthosilicate (TEOS) which is silicon oxide prepared from Si(OC₂H₅)₄, hydrogen silsesquioxane (HSQ), methyl silsesquioxane (MSQ), organosilicate glass (OSG), or an organic polymer-based material. In the case of advancing miniaturization of a semiconductor device, parasitic capacitance between wirings is significant and signal delay is increased; therefore, the relative permittivity of silicon oxide (k=4.0 to 4.5) is too high, and a material with k=3.0 or less is preferably used. In addition, since CMP treatment is performed after the wirings are embedded in the insulating films, the insulating films need to have high mechanical strength. The insulating films can be made porous to have a lower dielectric constant as long as their mechanical strength can be secured. The insulating films are formed by sputtering, CVD, a coating method including spin coating (also referred to as spin on glass (SOG)), or the like.

An insulating film functioning as an etching stopper for planarization treatment by CMP or the like that is performed after the wiring material is embedded in the insulating films 911, 912, 919, 920, and 933 may be additionally provided.

Each of the contact plugs 913, 915, 917, 921, and 925 is formed in such a manner that an opening (a via hole) with a high aspect ratio is formed in the insulating film and is filled with a conductive material such as tungsten. The opening is formed preferably by highly anisotropic dry etching and particularly preferably by reactive ion etching (RIE). The inner wall of the opening is covered with a barrier film (a diffusion prevention film) formed of a titanium film, a titanium nitride film, a stack of such films, or the like, and a material such as tungsten or polysilicon doped with phosphorus or the like fills the opening. For example, tungsten can be embedded in the via hole by blanket CVD, and an upper surface of the contact plug is planarized by CMP.

### Example

The memory management system in one embodiment of the present invention can be used for electronic devices in a wide variety of fields, such as digital signal processing devices, software-defined radio devices, avionic devices (electronic devices used in aircraft, such as communication systems, navigation systems, autopilot systems, and flight management systems), medical image processing devices, voice recognition devices, encryption devices, emulators for mechanical systems, and radio telescopes in radio astronomy. The memory management system can also be applied in ASIC prototyping and the field of bioinformatics.

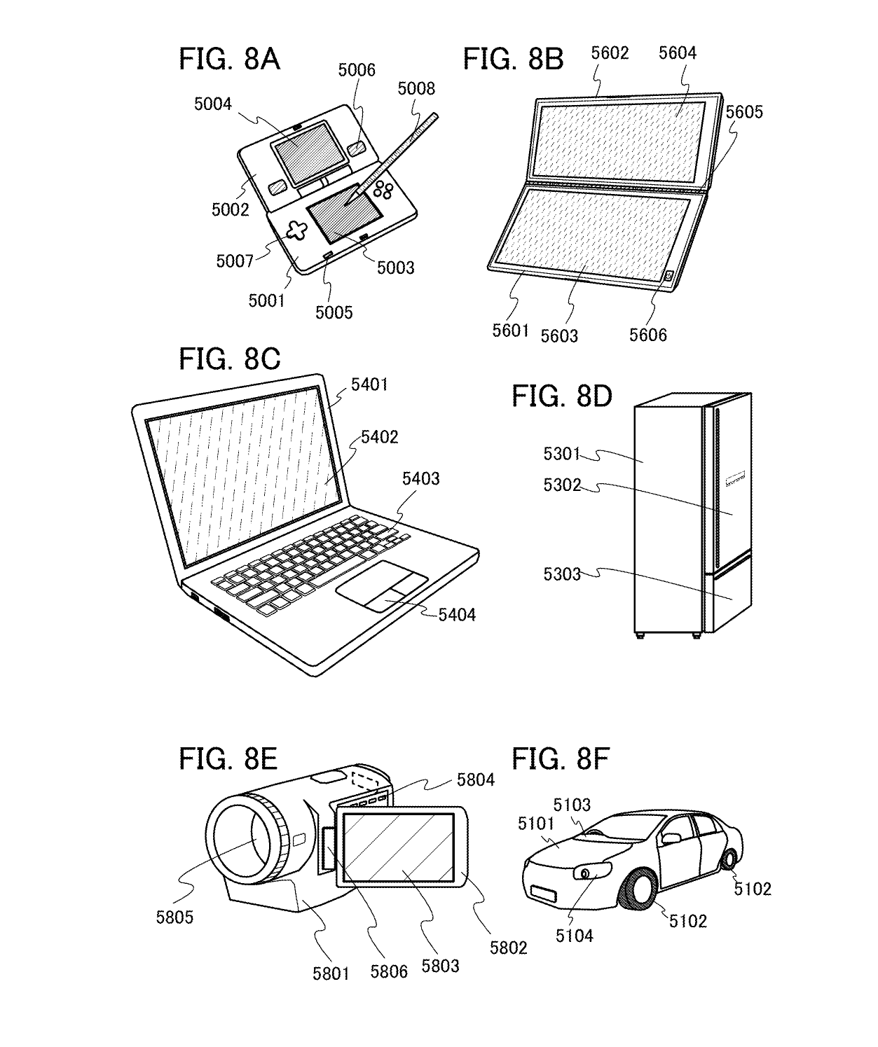

Examples of consumer products among such electronic devices are display devices, personal computers, and image reproducing devices provided with recording media (devices that reproduce the content of recording media such as digital versatile discs (DVDs) and have displays for displaying the reproduced images). Other examples of electronic devices that can include the memory management system in one embodiment of the present invention are mobile phones, game consoles including portable game consoles, portable information terminals, e-book readers, cameras such as video cameras and digital still cameras, goggle-type displays (head mounted displays), navigation systems, audio reproducing devices (e.g., car audio systems and digital audio players), copiers, facsimiles, printers, and multifunction printers. FIGS. 8A to 8F illustrate specific examples of these electronic devices.

FIG. 8A illustrates a portable game console. The portable game console in FIG. 8A includes a housing 5001, a housing 5002, a display portion 5003, a display portion 5004, a microphone 5005, a speaker 5006, an operation key 5007, a stylus 5008, and the like. Note that although the portable game console illustrated in FIG. 8A has the two display portions 5003 and 5004, the number of display portions included in the portable game console is not limited to two.

FIG. 8B illustrates a portable information terminal. The portable information terminal in FIG. 8B includes a first housing 5601, a second housing 5602, a first display portion 5603, a second display portion 5604, a joint 5605, an operation key 5606, and the like. The first display portion 5603 is provided in the first housing 5601, and the second display portion 5604 is provided in the second housing 5602. The first housing 5601 and the second housing 5602 are connected to each other with the joint 5605, and the angle between the first housing 5601 and the second housing 5602 can be changed with the joint 5605. Images on the first display portion 5603 may be switched in accordance with the angle at the joint 5605 between the first housing 5601 and the second housing 5602. A display device with a position input function may be used as at least one of the first display portion 5603 and the second display portion 5604. Note that the position input function can be added by provision of a touch panel in a display device. Alternatively, the position input function can be added by provision of a photoelectric conversion element called a photosensor in a pixel area of a display device.

FIG. 8C illustrates a laptop. The laptop in FIG. 8C includes a housing 5401, a display portion 5402, a keyboard 5403, a pointing device 5404, and the like.

FIG. 8D illustrates an electric refrigerator-freezer. The electric refrigerator-freezer in FIG. 8D includes a housing 5301, a refrigerator door 5302, a freezer door 5303, and the like.

FIG. 8E illustrates a video camera. The video camera in FIG. 8E includes a first housing 5801, a second housing 5802, a display portion 5803, operation keys 5804, a lens 5805, a joint 5806, and the like. The operation keys 5804 and the lens 5805 are provided in the first housing 5801, and the display portion 5803 is provided in the second housing 5802. The first housing 5801 and the second housing 5802 are connected to each other with the joint 5806, and the angle between the first housing 5801 and the second housing 5802 can be changed with the joint 5806. Images displayed on the display portion 5803 may be switched in accordance with the angle at the joint 5806 between the first housing 5801 and the second housing 5802.

FIG. 8F illustrates a passenger car. The passenger car in FIG. 8F includes a car body 5101, wheels 5102, a dashboard 5103, lights 5104, and the like.

This application is based on Japanese Patent Application serial No. 2012-124036 filed with Japan Patent Office on May 31, 2012, the entire contents of which are hereby incorporated by reference.

What is claimed is:

1. A memory device comprising a program for making a computer execute virtual storage management, the program allowing the computer to perform the steps of:
stopping power supply to each of a plurality of segments in a nonvolatile memory included in the computer;
looking up a table mapping a plurality of virtual addresses and a plurality of physical addresses included in each of the plurality of segments;
supplying power to a part of the plurality of segments; and
executing a process.

2. The memory device according to claim 1,
wherein during executing the process, the part of the plurality of segments is at least one of the plurality of segments including a physical address used in the process.

3. The memory device according to claim 1,
wherein the part of the plurality of segments is one segment necessary to continue execution of the process.

4. The memory device according to claim 1,
wherein during executing the process, the power is supplied to at least one segment among the part of the plurality of segments including k physical addresses (k is a natural number of 2 or more) used in the process, and power is temporarily supplied to at least one remaining segment among the part of the plurality of segments including a physical address of one or more and less than k used in the process.

5. The memory device according to claim 1,
wherein the program further makes the computer perform the steps of:
supplying power to one of the plurality of segments after stopping power supply to each of the plurality of segments, and
writing a new correspondence between a virtual address and a physical address into the table before looking up the table.

6. The memory device according to claim 1,
wherein the table comprises a flag to indicate whether power is supplied to one of the plurality of segments.

7. A computer comprising the memory device according to claim 1.

8. A memory device comprising a program for making a computer execute virtual storage management, the program allowing the computer to perform the steps of:
stopping power supply to each of a plurality of segments in a nonvolatile memory included in the computer;
looking up a cache for a table mapping a plurality of virtual addresses and a plurality of physical addresses included in each of the plurality of segments;
supplying power to a part of the plurality of segments; and
executing a process.

9. The memory device according to claim 8,
wherein during executing the process, the part of the plurality of segments is at least one of the plurality of segments including a physical address used in the process.

10. The memory device according to claim 8,
wherein the part of the plurality of segments is one segment necessary to continue execution of the process.

11. The memory device according to claim 8,
wherein during executing the process, the power is supplied to at least one segment among the part of the plurality of segments including k physical addresses (k is a natural number of 2 or more) used in the process, and power is temporarily supplied to at least one remaining segment among the part of the plurality of segments including a physical address of one or more and less than k used in the process.

12. The memory device according to claim 8,
wherein the program further makes the computer perform the steps of:
supplying power to one of the plurality of segments after stopping power supply to each of the plurality of segments, and
writing a new correspondence between a virtual address and a physical address into the cache before looking up the cache.

13. The memory device according to claim 8,
wherein the table comprises a flag to indicate whether power is supplied to one of the plurality of segments.

14. The memory device according to claim 8,
wherein the program further makes the computer perform the step of:
looking up the table after looking up the cache before supplying power to some of the plurality of segments.

15. A computer comprising the memory device according to claim 8.
